(19) United States
(12) Patent Application Publication
(10) Pub. No.: US 2004/0036627 A1
(43) Pub. Date: Feb. 26, 2004

(54) Emergency vehicle approaching alerting system

(76) Inventors: Jerry L. Knoski, Tucson, AZ (US); Barbara J. Knoski, Tucson, AZ (US); Daniel P. Marx, Tucson, AZ (US); T. Glenn Yuguchi, Tucson, AZ (US)

Correspondence Address: THOMAS J. FINN, RAYTHEON COMPANY, P.O. Box 902 (E0/E4/N119, El Segundo, CA, 90245-0902, US

(21) Appl. No.: 10/440,945

(22) Filed: May 19, 2003

Related U.S. Application Data
(60) Provisional application No. 60/382,440, filed on May 21, 2002.

(51) Int. Cl. G08G 1/00

(52) U.S. Cl. 340/902

(57) ABSTRACT

A system and method for warning a first vehicle of an approaching second vehicle. The novel system (100) comprises a transmitter system (13) located in the second vehicle (10) for transmitting an electromagnetic signal, and a receiver system (33) located in the first vehicle (20), the receiver system (33) including an antenna (31, 32, 62) for receiving the signal, and a receiver microchip (33) comprising a first circuit (330, 331, 332, 333) for processing the signal and outputting an electronic signal, and a second circuit (334, 339) for generating an audio and/or visual warning signal in response to the electronic signal. In the preferred embodiment, the receiver microchip (33) further includes a third circuit (336, 337, 338) for disabling one or more sound producing sources (44, 54, 35a, 35b) within the first vehicle in response to the electronic signal. In a first illustrative embodiment, the receiver system (33) is implemented as part of a telematics suite or car radio (30). In an alternate embodiment, the receiver (33) system is implemented as an independent wireless receiver module (61).

### RELATED APPLICATIONS

This application claims the benefit of U.S. Provisional application, Serial No. 60/382,440, filed May 21, 2002, entitled “EMERGENCY VEHICLE WARNING SYSTEM”.

### BACKGROUND OF THE INVENTION

1. Field of the Invention

The present invention relates to vehicle warning systems. More specifically, the present invention relates to systems for warning vehicles of the approach of an emergency vehicle.

2. Description of the Related Art

Today's roadway vehicles are typically “sound-proof” and when operated with the air conditioning on, windows closed, and entertainment systems on, it is difficult for the driver to hear emergency vehicle sirens. The problem is compounded with the installation of automotive telematics (the wireless delivery of communication, information & other content, e.g., voice messages, e-mail) between the vehicle, the occupants and external sources. Telematics will distract drivers further. Failure to hear an emergency vehicle until it is very close causes a delayed reaction which requires the emergency vehicle to travel slower (delaying the emergency response), and the closeness when it is detected causes some drivers to overreact and change lanes into other traffic or to stop short. Failure to hear trains approaching roadway crossings is a frequent cause of train and roadway vehicle accidents. Each year in the United States there are thousands of intersection accidents involving emergency vehicles such as fire trucks, ambulances and law enforcement vehicles. These accidents kill and injure thousands of people. Forty percent of the firefighters that are killed on duty are killed in accidents while going to the scene of a fire or emergency. Roadway vehicle and train collisions in the U.S. cause over 400 deaths per year and thousands of injuries. In the U.S., boat collisions with other boats kill 75 persons annually and thousands of injuries.

The existing approaches to solve this problem are very expensive to implement and expensive for the ultimate user and therefore have not been accepted by the automotive industry. One system called Safety Warning System operates in the gigahertz range and can only be received by vehicles that have radar detectors installed. Radar detector prices range from $50 to $350 and in some states radar the detectors are outlawed. Other attempts use audible techniques to detect a siren and they can be ineffective in certain weather conditions. In most cases the only economic way to implement the existing concepts is via installation as original equipment. The automotive industry has not implemented the existing concepts because of the size, weight, complexity and cost of the components. Additionally, the installation of the existing concepts in a motor vehicle as an aftermarket unit would be very expensive because of the rewiring and component modifications required.

Hence, a need exists in the art for an improved system or method for warning vehicles of the approach of an emergency vehicle which offers smaller size, weight, and cost than prior art systems.

### SUMMARY OF THE INVENTION

The need in the art is addressed by the system and method for warning a first vehicle of an approaching second vehicle of the present invention. In the illustrative embodiment, the second vehicle is an emergency vehicle. In the most basic and generic structural form, the inventive emergency vehicle warning system comprises a transmitter system located in the second vehicle for transmitting an electromagnetic signal, and a receiver system located in the first vehicle, the receiver system including an antenna for receiving the signal, and a receiver microchip comprising a first circuit for processing the signal and outputting an electronic signal, and a second circuit for generating an audio and/or visual warning signal in response to the electronic signal. In the illustrative embodiment, the second circuit includes a voice synthesizer, and a flasher coupled to a visual display. In the preferred embodiment, the receiver microchip further includes a third circuit for disabling one or more sound producing sources within the first vehicle in response to the electronic signal. In a first illustrative embodiment, the receiver system is implemented as part of a telematics suite or car radio. In an alternate embodiment, the receiver system is implemented as an independent wireless receiver module.

### BRIEF DESCRIPTION OF THE DRAWINGS

FIG. 1 is a basic logic diagram showing an illustrative embodiment of the present invention wherein the receiver is designed for installation as original equipment.

FIG. 2 is a basic logic diagram showing an alternate embodiment of the present invention wherein the receiver is designed to be installed as an aftermarket unit.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

One purpose of this invention is to improve traffic safety by ensuring all vehicle drivers receive sufficient advanced warning of approaching emergency vehicles and trains. In accordance with the teachings of the present invention, this can be accomplished by bringing the warning signals “into” the vehicle using one of two unique low cost RF (radio frequency) receiver devices and one low cost transmitter device. (One of the receiver devices is for installation as original equipment and the second is designed to be installed as an aftermarket unit.) The devices are microchip designs and can be mass produced at very little cost. A very low frequency is used to minimize component cost. Existing components in most roadway vehicles are used to further minimize cost. A wireless, almost credit card size receiver, can be produced at very low cost and can be installed in any aftermarket vehicle with virtually no installation cost. Because the invention lowers the unit size, weight and cost so significantly, there is a good likelihood there will be automotive industry and customer acceptance. Acceptance and implementation will save lives and reduce injuries.

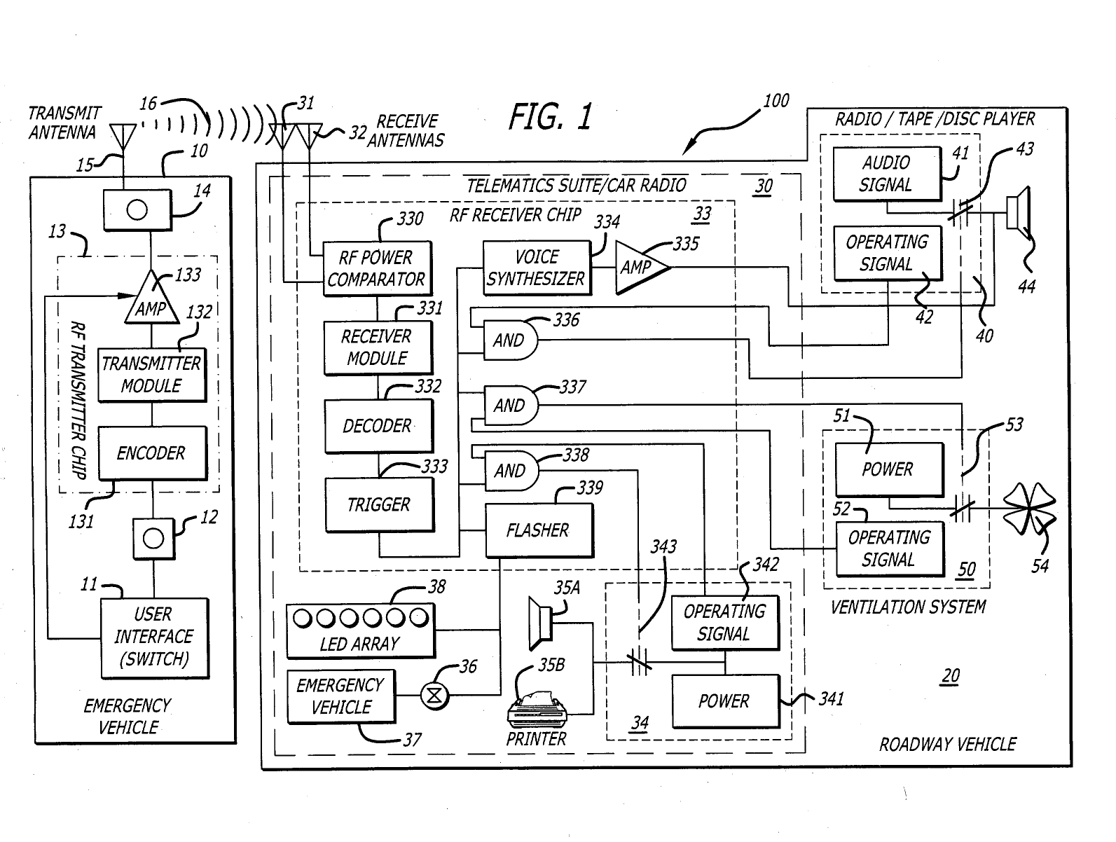

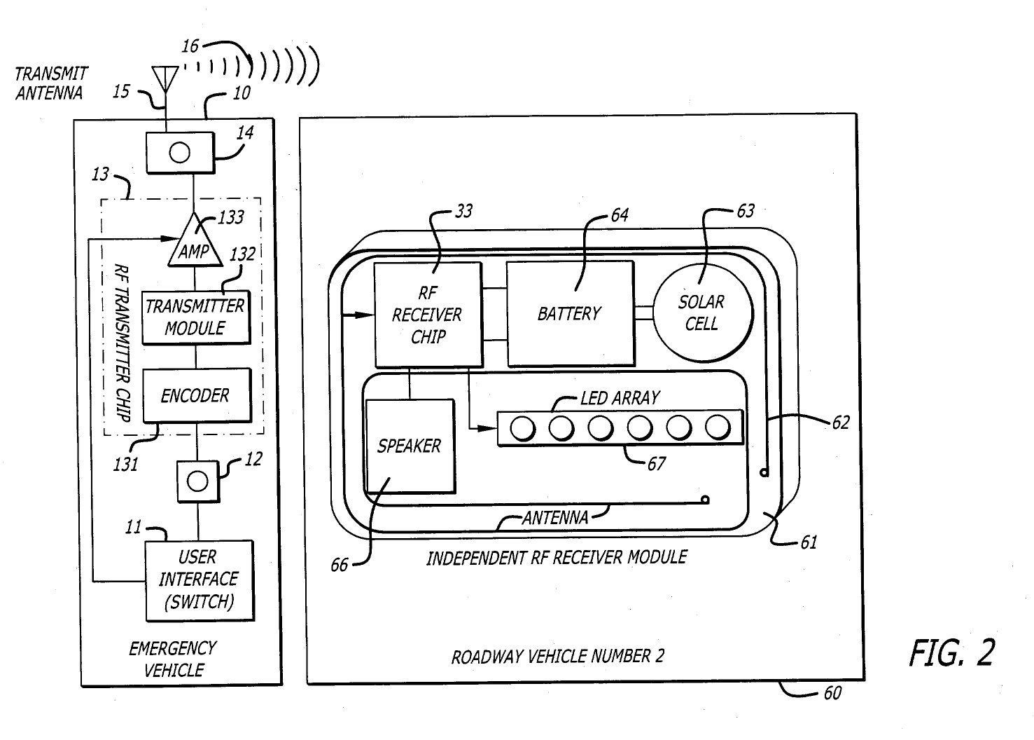

FIGS. 1 and 2 are basic logic diagrams showing the overall function of the emergency vehicle warning system. FIG. 1 shows an illustrative embodiment of the invention wherein the receiver is designed for installation as original equipment. FIG. 2 shows an alternate embodiment wherein the receiver is designed to be installed as an aftermarket unit.

In the most basic and generic structural form, the inventive emergency vehicle warning system 100 comprises a vehicle 10 which is designated to respond to exigency conditions including vehicles such as fire, law enforcement, ambulance and military alert vehicles, herein referred to as emergency vehicles. The emergency vehicle 10 is equipped with a traffic alerting device such as a radio frequency (RF) transmitter 13 with a transmitting antenna 15. In the preferred embodiment, the antenna 15 is directional, in a hemisphere pointing to the front of the emergency vehicle. This system is based on a microchip referred to as a RF transmitter chip 13, comprised of an encoder 131, a transmitter module 132, and an amplifier 133. In the illustrative embodiment, they are operated in conjunction with a user interface switch 11 and two light indicators 12 and 14 located before and after the transmitter chip 13, respectively. In the preferred embodiment, the user interface switch 11 allows the operator to adjust the range of the signal by adjusting the output power (through the amplifier 133) of the transmitter 13. The user interface switch 11 may be the same switch which operates an emergency vehicle siren.

The invention is adapted for use with a second vehicle 20, one of a plurality, containing vehicles such as passenger cars, trucks and busses; herein referred to as roadway vehicles. As shown in FIG. 1, this vehicle would be equipped with an emergency vehicle alert receiving system 33 based on a microchip and referred to as a RF receiver chip 33. This unit is designed to be installed as a part of a telematics suite or automobile car radio 30, during their manufacture. The vehicle alert receiving system 33 is to be coupled with and respond to a radio frequency (RF) signal received via its omni-directional radio antenna 31, or a telematics RF antenna 32, or both. Upon receiving a RF signal, the alert receiving system 33 has the capability of sending electrical output signals, in the appropriate form, to other systems or units within the vehicle. The chip 33 contains RF receiver components such as a RF comparator 330, a RF receiver module 331, a decoder 332, and a trigger 333 for processing the RF signal. The processed signal is used to support other functions within the telematics suite, namely to initiate a voice synthesizer 334, initiate a flasher 339, and serve a signal to three AND gates 336, 337 and 338. The chip also contains an amplifier 335 to amplify the synthesized voice signal from the voice synthesizer 334 to the entertainment system radio 40.

In an alternate embodiment, the receiver chip 33 can be designed as a transceiver chip capable of handling both receive and transmit functions. This transceiver chip can then also be used as the transmitter chip 13 in the emergency vehicle 10.

In the illustrative embodiment, the second vehicle 20 further includes an interior compartment warning indicator system 30 based on the telematics/radio, comprised of an electrical flasher 339, within the RF receiver chip 33, (as used in a vehicle turn signal or hazard warning light systems), and a lamp 36, which illuminates a dashboard “Emergency Vehicle” indicator 37, or a separate lighting system such as an LED array 38.

If the vehicle 20 is equipped with a radio, tape, or disc player, the vehicle warning system 100 would also include an emergency entertainment control unit 40, which upon receiving a signal from the RF receiver chip 33 will disengage the signals of certain radio or tape/disc player components to the speaker or speakers 44, provided the radio or tape/disc player components are operating, an audio signal 41 is being produced, and an operating signal 42 is sent to the RF receiver chip 33. The unit 40 also includes a normally closed switch 43, which allows the audio signal 41 to reach the speakers 44.

In the illustrative embodiment, the second vehicle 20 further includes an emergency ventilation control unit 50, which upon receiving a signal from the RF receiver chip 33, will disengage the power to the fan motor 54, provided the fan motor 54 is operating, a power signal 51 is being produced, and an operating signal 52 is sent to the RF receiver chip 33. The unit 50 also includes a normally closed switch 53 which allows the power 51 to reach the fan motor 54.

In the preferred embodiment, the second vehicle 20 includes an emergency telematics suite control unit 34, which upon receiving a signal from the RF receiver chip 33 will disengage the power to the telematics speaker 35a and printer 35b, provided the telematics units are operating, a power signal 341 is being produced, and an operating signal 342 is sent to the RF receiver chip 33. The unit 34 also includes a normally closed switch 343 which allows the power 341 to reach the speaker 35a and printer 35b.

In an alternative embodiment, a roadway vehicle 60 is equipped with an independent RF receiver module 61 that is completely self-contained, as shown in FIG. 2. Within its configuration is an antenna 62, a solar cell 63 for charging a battery 64, which provides power to the RF receiver chip 33, which is the same chip as the RF receiver chip 33 in the first embodiment of FIG. 1. The module 61 also contains it's own speaker 66 and a LED array 67 to provide audible and visual alarms to the vehicle operator. These units also receive power from the battery 64.

In operation the invention provides warning to roadway vehicle drivers in the following manner. In an emergency response, the emergency vehicle turns on the RF transmitter 13 along with or independent of the siren using a push/pull function of the operator interface switch 11. The RF transmitter 13 operates on a reserved frequency and the transmission distance is limited by the output power of the transmitter and controlled by the rotation function of the operator interface switch 11 and the amplifier 133. In the preferred embodiment, the transmitter 13 operates at a low RF frequency such as the AM band to reduce cost and chip size.

Roadway vehicles 20 possessing the invention's systems/components would have an operating receiver 33, designed to receive the same frequency as that transmitted by the emergency vehicle 10, when the roadway vehicle ignition key is turned on or in the case of an independent RF receiver module 61 it would be on at all times. With the roadway vehicle in receiving range of the emergency vehicle transmission, the receiver 33 via the omni-directional antenna (31 and/or 32) would detect the signal. The RF receiver chip 33 will process this signal, and in an appropriate electrical form send it to the flasher 339 which produces a flashing (off and on) illumination of the “Emergency Vehicle” indicator 37 and/or the LED array 38.

Simultaneously, the signal from within the RF receiver chip 33 goes to the voice synthesizer 334 and therein to the resident AND gates 336, 337 and 338. Provided the roadway vehicle has an entertainment system such as a radio or tape/disc player operating, an “on” or “operating” signal 42 from the unit is sent to the first AND gate 336. Upon receipt of both signals, the AND gate sends a signal to open the normally closed switch 43, which interrupts the audio signal 41 from the operating unit to the speaker 44, silencing the entertainment system.

The voice synthesizer 334 consists of a programmable read only memory (PROM) that is programmed to digitally replicate a voice stating “Emergency Vehicle Approaching”, or other suitable message. This signal is amplified within the RF receiver chip by the amplifier 335 and is sent to the speaker 44. The “Emergency Vehicle Approaching” statement is repeated over and over until the RF transmission from the emergency vehicle is out of range.

If the vehicle ventilation system fan motor 54 is operating, or if telematics units such as printers 35b or speakers 35a are operating, they are also disabled/interrupted by the receipt of operating signals to their respective AND gates (337 and 338) within the RF receiver chip and their normally closed switches, 53 and 343 respectively. They are automatically reactivated when RF transmission from the emergency vehicle is out of range.

A roadway vehicle that has the independent RF receiver module 61 receives the transmitted signal via its internal antenna 62, and this signal is processed by the RF receiver chip 33 in the same manner as described above. The output signals from the chip 33 is a synthesized voice stating “Emergency Vehicle Approaching” which goes to the speaker 66, and a flashing signal to the LED array 67. These signals terminate when the RF signal to the antenna dissipates. Power is provided to the RF receiver chip 33, the speaker 66, and the LED array 67 by the internal battery 64, and the battery 64 is kept charged by the solar cell 63. The independent RF receiver module 61 may be attached to the roadway vehicle by many different methods, e.g., with adhesive or tape, or using a clip to attach it to the windshield, rearview mirror, sun visor or any place conspicuous to the driver.

The description of the preferred embodiment primarily refers to emergency vehicles but the transmitter could be used on trains to provide advance warning when approaching a roadway intersection. In this application the transmitter antenna should be directional. Transmitters should be located on the locomotive unit to provide forward warning and on the last car of the train to warn motorists when the train is backing across a roadway. The train transmitter would transmit a special code to indicate it was a train instead of an emergency vehicle. The roadway vehicle RF receiver chip could decode this message and send a unique message to the voice synthesizer to warn of a train approach.

Similar transmitter and receiver units could be developed and used by commercial and recreational boats, aircraft and other vehicles.

The invention as described assumes the vehicles are manufactured with the inventive systems/components installed and over time all vehicles would have a complete system. Emergency vehicle warning could also be provided by installing and using individual units, such as the RF system by itself, or other portions of the described system. Likewise equivalent or substitute units or subsystems could be manufactured and installed as aftermarket units to provide warning of emergency vehicles to automobiles that were not originally equipped with a warning system. For example, the vehicle alert receiving could be used with any combination to the dashboard warning system, the AND gate and switch and the voice warning unit, or the voice warning unit could be replaced with a buzzer or other audible device and it could be used in conjunction with the other inventive system as described.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A system for warning a first vehicle of an approaching second vehicle comprising:
a transmitter system located in said second vehicle for transmitting an electromagnetic signal; and
a receiver system located in said first vehicle, said receiver system including an antenna for receiving said signal and a receiver microchip comprising:
first means for processing said signal and outputting an electronic signal, and
second means for generating an audio and/or visual warning signal in said first vehicle in response to said first means.

2. The invention of claim 1 wherein said second vehicle is an emergency vehicle.

3. The invention of claim 1 wherein said second vehicle is a train.

4. The invention of claim 1 wherein said first and second vehicles are boats.

5. The invention of claim 1 wherein said transmitted signal is a radio frequency signal.

6. The invention of claim 1 wherein said receiver system is implemented as part of a telematics suite or car radio.

7. The invention of claim 1 wherein said receiver system is implemented in an independent wireless receiver module.

8. The invention of claim 1 wherein said first means includes a comparator, a receiver module, a decoder, and a trigger.

9. The invention of claim 1 wherein said antenna is a radio antenna of said first vehicle.

10. The invention of claim 1 wherein antenna is a telematics antenna of said first vehicle.

11. The invention of claim 1 wherein said second means includes a voice synthesizer and an amplifier.

12. The invention of claim 11 wherein said voice synthesizer and amplifier are coupled to a speaker in said vehicle.

13. The invention of claim 11 wherein said voice synthesizer and amplifier are coupled to a built-in speaker in an independent wireless receiver module.

14. The invention of claim 1 wherein said second means includes a flasher unit.

15. The invention of claim 14 wherein said flasher unit is coupled to a visual display.

16. The invention of claim 15 wherein said visual display is an LED array.

17. The invention of claim 15 wherein said visual display includes a lamp illuminating a dashboard indicator.

18. The invention of claim 1 wherein said receiver microchip further includes third means for disabling one or more sound producing sources within said first vehicle in response to said first means.

19. The invention of claim 18 wherein said third means includes one or more AND circuits, each AND circuit inputting said electronic signal from said first means and an operating signal from said source, and outputting a signal to a switch in said source.

20. The invention of claim 18 wherein said sources include a radio and/or tape player and/or disc player.

21. The invention of claim 18 wherein said sources include a ventilation system

22. The invention of claim 19 wherein said sources include a telematics unit.

23. The invention of claim 7 wherein said independent wireless receiver module includes a battery and solar cell for providing power to said receiver microchip.

24. The invention of claim 7 wherein said independent wireless receiver module includes a built-in antenna.

25. The invention of claim 1 wherein said transmitter system includes a transmitter microchip coupled to a transmitting antenna.

26. The invention of claim 25 wherein said transmitter microchip includes an encoder and a transmitter module.

27. The invention of claim 26 wherein said transmitter system further includes a user interface switch coupled to said transmitter microchip for activating and deactivating the system.

28. The invention of claim 1 wherein said user interface switch is coupled to said amplifier for adjusting the range of the transmitted signal.

29. A system for warning a first vehicle of an approaching second vehicle comprising:
a transmitter system located in said second vehicle for transmitting a radio frequency signal; and
a receiver system located in said first vehicle, said receiver system including an antenna for receiving said signal and a receiver microchip comprising:
a first circuit for processing said signal and outputting an electronic signal;
a second circuit for generating an audio and/or visual warning signal in said first vehicle in response to said electronic signal; and
a third circuit for disabling one or more sound producing sources within said first vehicle in response to said electronic signal.

30. An independent wireless receiver module for warning a first vehicle of an approaching second vehicle comprising:
an antenna for receiving a signal transmitted by said second vehicle;
a receiver microchip comprising:
a first circuit for processing said signal and outputting an electronic signal, and
a second circuit for generating an audio and/or visual warning signal in said first vehicle in response to said first means;
a speaker and/or visual display coupled to said second circuit;
a battery for providing power to said receiver microchip; and
a solar cell for charging said battery.

31. A method for warning a first vehicle of an approaching second vehicle comprising:
transmitting a radio frequency signal from said second vehicle;
receiving said signal in said first vehicle;
processing said received signal with a receiver microchip;
generating an audio and/or visual warning signal in said first vehicle in response to said signal; and
disabling one or more sound producing sources within said first vehicle in response to said signal.
